(19) United States
(12) Patent Application Publication
(10) Pub. No.: US 2021/0348990 A1
(43) Pub. Date: Nov. 11, 2021

(54) METHOD FOR PREPARING TEST SAMPLES FOR SEMICONDUCTOR DEVICES

(71) Applicant: SHANGHAI HUALI INTEGRATED CIRCUIT CORPORATION, Shanghai (CN)

(72) Inventors: Qiang CHEN, Shanghai (CN); Yanrong Qiu, Shanghai (CN); Jinde Gao, Shanghai (CN)

(21) Appl. No.: 17/185,819

(22) Filed: Feb. 25, 2021

(30) Foreign Application Priority Data
May 8, 2020 (CN) 202010382602.3

(51) Int. Cl. G01N 1/30; G01N 23/04; G01N 1/06

(52) U.S. Cl. CPC G01N 1/30; G01N 2223/6116; G01N 1/06; G01N 23/04

(57) ABSTRACT

The present application provides a method for preparing a test sample of a semiconductor device. In an initial orientation, a side surface of the sample substrate exposes a cross section of the semiconductor device to be tested. The semiconductor device has a porous structure on the cross section. Then a filling material is deposited on the porous structure on the cross section to be tested. Next, cutting the sample substrage in a direction perpendicular to the sample substrate, when the sample substrate is in the initial orientation to obtain a sheet test sample, wherein a side surface of the sheet test sample is the cross section to be tested. The method mitigate porous structure effect on a prepared TEM sample, thereby improving quality of a TEM image.

### CROSS-REFERENCES TO RELATED APPLICATIONS

This application claims priority to Chinese patent application No. CN202010382602.3 filed on May 8, 2020 at CNIPA, and entitled “METHOD FOR PREPARING TEST SAMPLES OF SEMICONDUCTOR DEVICES”, the disclosure of which is incorporated herein by reference in entirety.

### TECHNICAL FIELD

The present application relates to the field of semiconductors, in particular, to a method for preparing a TEM sample in the field of semiconductor test analysis.

### BACKGROUND

Since the early days when Dr. Jack Kilby of Texas Instruments invented the integrated circuit, scientists and engineers have made numerous inventions and improvements in the areas of semiconductor devices and processes. The sizes of semiconductor devices have been significantly shrank in the past 50 years, leading to a continuous increase in processing speed and a continuous reduction in power consumption. Up to now, the development of silicon transistors generally follows the Moore's Law. The Moore's Law generally indicates that the number of transistors in a dense integrated circuit doubles approximately every two years. Currently, the semiconductor industry has developed towards nodes below 20 nm, and some are working on the 14-nm process. The diameter of a silicon atom is about 0.2 nm, which means that the distance between two independent components manufactured by means of the 20-nm process is only about the sum of the diameters of a hundred silicon atoms.

Therefore, the manufacturing of semiconductor devices has become increasingly challenging towards the feasible physical limit as approaching 10 nm or less critical dimensions. To ensure device quality, test samples must be prepared to determine if the produced semiconductor devices satisfy the process specifications.

Due to the extremely high resolution, transmission electron microscope (TEM) is one of the most commonly used techniques for physical property analysis for integrated circuit chip samples during advanced processing. Generally speaking, the thickness of a TEM sample applicable to a transmission electron microscope is only in tens of nanometers. The TEM sample is more likely to reveal an accurate device structure if it is at least less than 100 nm thick. Currently, Apply a Focused Ion Beam (FIB) technique to accurately position and prepare a TEM sample has become the most important TEM sample preparation method in the chip failure analysis field.

During preparation of a chip's TEM sample with FIB, if the chip sample consists of multiple materials as it usually does or has uneven thickness , particularly if the chip sample is porous, FIB's ion beam can scratch TEM sample surface, leaving lines of defects referred to as the “curtain effect”. FIG. 1A illustrates a schematic diagram of the TEM sample with the “curtain effect”, and FIG. 1B shows an image of the TEM sample being scratched by the ion beam. These ion scratches in FIG. 1A and FIG. 1B seriously affected the imaging quality of the TEM sample, so the sample cannot be used for subsequent research and analysis. Furthermore, sample damage by FIB's ion beam scratching directly impact the process yield of preparing ultra-thin samples, making it very difficult and costly for using FIB technique for ultra-thin sample analysis.

In view of the above, there is an urgent need for a method of preparing a chip's TEM test sample with a porous structure, where the harmful effect caused by the porous structure can be avoided, so that the TEM sample quality can be improved effectively and good TEM images can be achieved.

### BRIEF SUMMARY

A brief overview of one or more embodiments is provided below. This overview is neither intended to identify all the elements of the embodiments nor attempts to define all the scopes of the embodiments. It is merely a simplified form as a prelude to the more detailed description provided later.

The present application provides a method for preparing a test TEM sample of a semiconductor chip, specifically the method comprises a number of steps of:

providing a sample substrate, wherein in an initial orientation, a side surface of the sample substrate exposes a cross section of a semiconductor device, wherein the cross section of the semiconductor device is to be tested, and wherein the the cross section comprises a porous structure;

depositing a filling material on the porous structure; and

cutting in a direction perpendicular to the sample substrate when the sample substrate is in an initial orientation to obtain a sheet test sample, wherein a side surface of the sheet test sample is the cross section to be tested.

In some examples, depositing a filling material on the porous structure further comprises steps of: rotating an orientation of the sample substrate so the cross section to be tested is a top surface; wherein the filling material is deposited perpendicularly; and rotating the orientation of the sample substrate to the initial orientation.

In some examples, the filling material is deposited in a process of electron beam assisted deposition.

In some examples, the filling material is metal platinum (Pt) or metal tungsten (W).

In some examples, the sample substrate is provide in steps of: providing an initial substrate comprising the semiconductor device; performing splitting processing on the initial substrate; and selecting a portion of the initial substrate obtained after splitting as the sample substrate, wherein the portion contains the cross section of the semiconductor device to be tested.

In some examples, before the cutting of the sample substrate in the initial orientation, the method further comprises: polishing the side surface of the sample substrate.

In some examples, the polishing is performed by a focused ion beam.

In some examples, the perpendicular cutting is performed by a focused ion beam.

In some examples, a thickness of the sheet test sample is less than 100 nanometers.

In some examples, a side surface of the sheet test sample is imaged by a transmission electron microscope.

According to the method for preparing a test sample of a semiconductor device provided by the present application, the harmful effect caused by a porous structure can be effectively avoided by filling the porous structure before a TEM sample is formed, effectively improving the quality of the TEM sample, and thereby effectively improving the imaging quality of a TEM image.

### BRIEF DESCRIPTION OF THE DRAWINGS

The above-mentioned features and advantages of the present application can be better understood by reading the detailed description of the embodiments of the present disclosure with reference to the following drawings. In the drawings, various components are not necessarily drawn to scale, and components with related similar characteristics or features may have the same or similar reference numerals.

FIG. 1A illustrates a schematic diagram of the “curtain effect”.

FIG. 1B illustrates an image of a TEM sample which is scratched by the ion beam in the current practice.

FIG. 2 illustrates a flowchart of a preparation method according to an embodiment of the present application.

FIG. 3 illustrates a flowchart of the steps to form a filler according to an embodiment of the present application.

FIGS. 4-10 respectively illustrate various steps of the TEM sample preparation method according to of some embodiments of the present application.

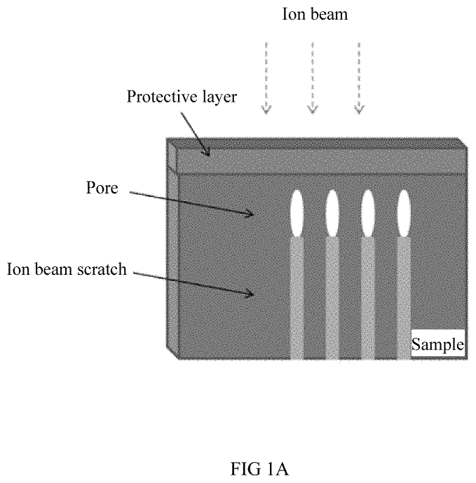

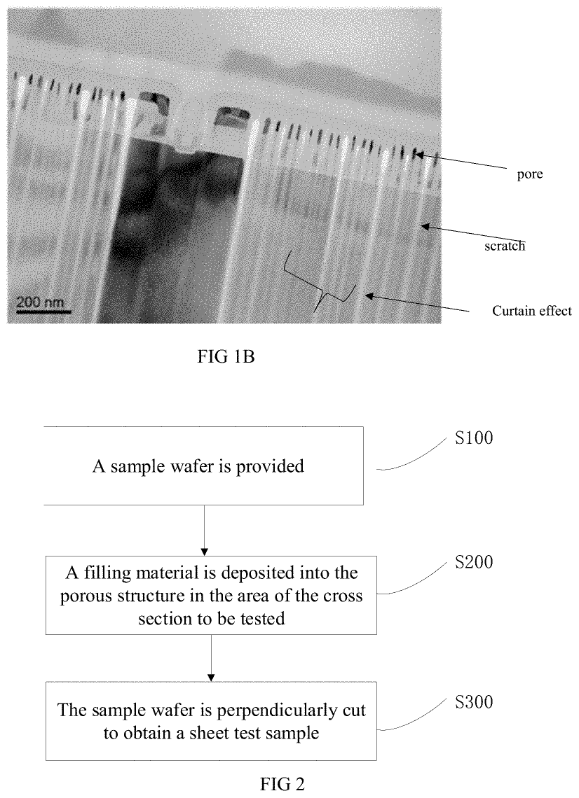

### DETAILED DESCRIPTION OF THE DISCLOSURE

The present application is described in detail below with reference to the drawings and specific embodiments. It should be noted that the following aspects described with reference to the drawings and specific embodiments are merely intended for description and should not be construed as limiting the protection scope of the present application.

The application relates to the field of semiconductor device tests, in particular to a method for preparing a test sample of a semiconductor device. According to the method for preparing a test sample of a semiconductor device provided by the present application, the harmful effect caused by a porous structure can be effectively avoided by filling the pores before the final TEM sample is made, thereby improving the yield of TEM samples, and the quality of the TEM images.

The following description is provided to enable a person skilled in the art to implement and use the present application and apply it into specific application scenarios. Various modifications and uses in different applications in a relatively wide range by a person skilled in the art might be extensions of the embodiments disclosed herein. Therefore, the present application is not limited to the embodiments given herein, but should be granted the broadest scope consistent with the principle and novel features disclosed herein.

In the following detailed description, many specific details are set forth to provide a more thorough understanding of the present application. However, the present application may not necessarily be limited to these specific details. In other words, to avoid obscuring the present application, certain structures and devices shown in the form of block diagrams rater than in details may be there as supporting pieces or for illustrating purpose only.

Readers should pay attention to all files and documents submitted along with this specification that are open to the public for consulting this specification, and the contents of all of these files and documents are incorporated hereinto by reference. Unless otherwise directly stated, each feature disclosed in this specification (including any appended claims, abstract, and drawings) is merely an example of a set of equivalent or similar features, therefore can be replaced by alternative features for achieving the same, equivalent, or similar purpose.

It should be noted that when used, the signs left, right, front, rear, top, bottom, front, back, clockwise, and counterclockwise are only used for the purpose of convenience, and do not imply any specific direction. In fact, they are used to reflect a relative orientation and/or orientation between various parts of an object.

As used herein, the terms “over”, “under”, “between”, and “on” refer to a relative position of one layer relative to another layer. Likewise, for example, a layer deposited or placed over or under another layer may directly contact the other layer or may be separated from the other layer by one or more intermediate layers. Furthermore, a layer deposited or placed between layers may directly contact the layers or may be separated from the layers by one or more intermediate layers. In contrast, a first layer “on” a second layer is in contact with the second layer. In addition, a relative position of one layer relative to the other layers is provided (assuming that deposition, modification, and film removal operations are performed relative to a base substrate, regardless of the absolute orientation of the substrate).

First FIG. 2 illustrates a flowchart of a preparation method according to an embodiment of the present application. Referring to FIG. 2, the preparation method provided by the present application includes: step S100: a chip test sample is provided; step 200: a filling material is deposited to fill the porous structure in a testing section ; and step S300: the chip test sample is cut perpendicularly the chip surface to obtain a sheet test sample.

Specifically, referring to FIG. 4 to understand the provision of the chip test sample in step S100. The chip test sample shown in FIG. 4 is in an initial position. In the initial position, a front side surface of the chip test sample exposes the front surface of the testing cross section. The to-be-viewed cross section of the final TEM sample is the surface marked as “cross section to be tested” in FIG. 4. It is often not the top surface of the chip. The initial position refers to an orientation that the test chip still has its top surface upward on the wafer and its bottom surface parallel to the wafer. It can be understood that, in the initial position, the front side surface or the cross section to be tested corresponds to a cross section of the wafer in the perpendicular direction to the wafer. It can be seen from FIG. 4 that the chip sample has many pores shown on the cross section to be tested.

In an embodiment, the chip test sample shown in FIG. 4 is obtained by performing splitting processing on an initial test chip . The splitting processing is a purely physical way of splitting a substrate such as a piece of wafer into two parts by applying a force such as scribing. Furthermore, since the wafer has a crystalline phase, a cross section in the perpendicular direction of the test sample obtained after the splitting processing can be well controlled to expose the cross section to be tested.

Furthermore, different from the way of performing cutting by a focused ion beam, the splitting processing does not cause an ion scratch effect on the porous structure because it tends to break apart the wafer along the crystal faces. Therefore, the splitting processing does not cause damage to the porous structure of test sample as in FIB process.

In step S200, in one aspect of the preparation method, the filling material needs to be deposited into the pores exposed on the cross section to be tested, thereby mitigating the effect caused by subsequent use of the focused ion beam when cutting the test sample.

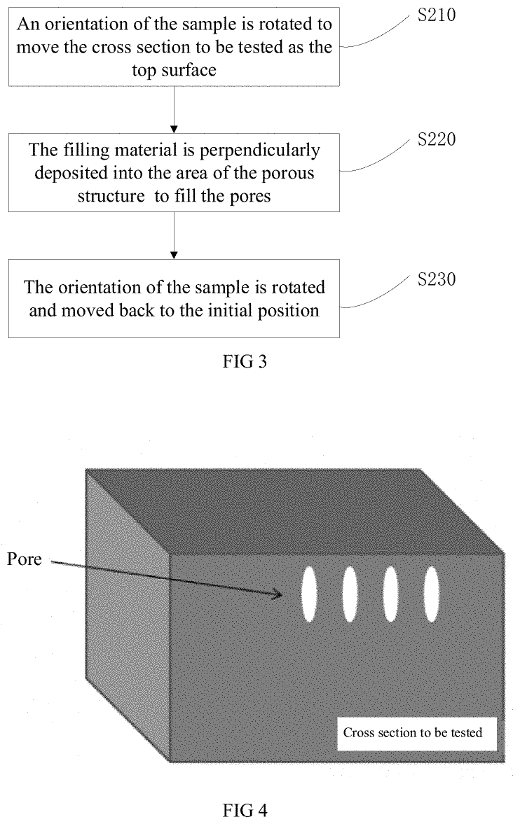

Referring to FIG. 3 illustrates a flowchart of steps in a specific implementation method for forming the filler in the porous structure on the be tested cross section according to an embodiment of the present application. Referring to FIG. 3, the steps forming a filler in the porous structure exemplarily include: step S210: a position of the chip test sample is adjusted so the cross section to be tested turns into a front surface; step S220: the filler is deposited into an area where the porous structures are located to fill the pores, the filler beam can be deposited perpendicular to the testing surface or with an angle; and step S230: the position of the test sample is adjusted to the initial position if necessary.

Referring to FIGS. 5, 6, and 7 for better understanding the specific implementation method for forming the filler in the porous structure on the to be tested cross section surface in step S200. First, referring to FIG. 5, in step S210, the position of the test sample obtained in step S100 is rotated, so the cross section exposing the to-be-tested of the test sample that is at the top, that is, the cross section to be tested is the top surface as this time of the test sample.

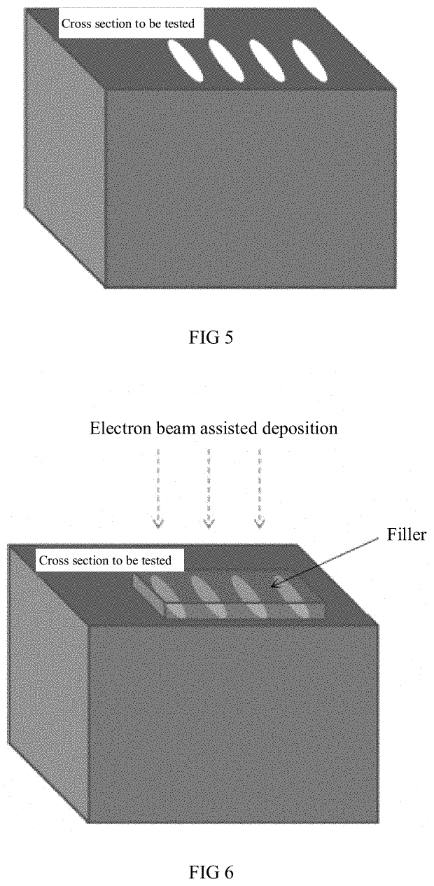

Referring to FIG. 6, in step S220, the filling material is deposited in the direction perpendicular to the testing surface into the area to fill the pores in the porous structure. In an embodiment, the filling material is deposited by means of electron beam assisted deposition or ion beam assisted deposition. Since the porous structure to be tested in the chip test sample has the similar size as the structure of the device on the test sample, the depth of the porous structure cannot be accurately determined after the splitting processing. In order to fill the pores in the porous structure as fully and densely as possible, in step S210, the test sample is erected, so that an electron beam or ion beam in step S220 can be set parallel to the porous structure walls in a prolonged form so the electron beam or ion beam can reach the deepest into the pores. The deeper the electron beam or ion beam reaches in the pores, the better the filler deposition effect is. It is understood that, in the above embodiment, in order to ensure the pores in the porous structure are very well filled, there may be a protruding portion formed above the surface of the test sample.

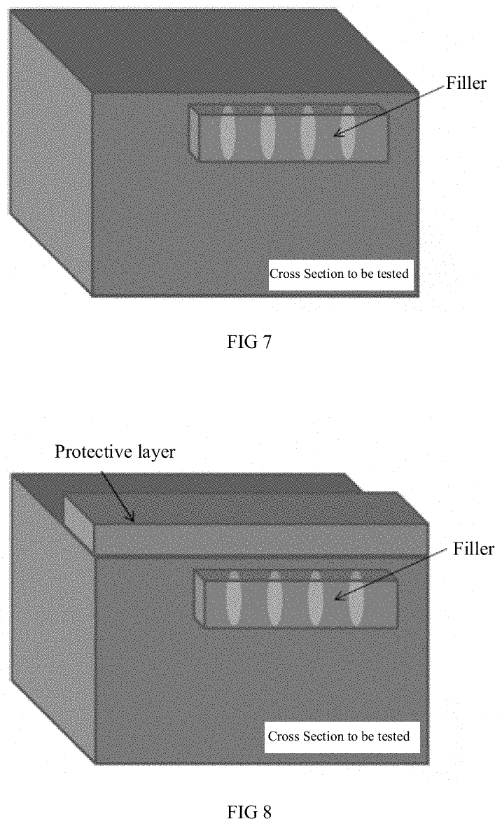

Referring to FIG. 7, in step S230, the orientation of the test sample which has pores in the porous structure filled with the filling material is rotate again back to the initial orientation, i.e., one the cross section to be tested is the side surface. In FIG. 6, the filler protruding portion on the surface of the test sample now extends out laterally after the orientation is rotated in FIG. 7.

After step S200, the porous structure exposed on the to be tested cross section is densely filled with the filler. Therefore, in subsequent steps preparing for the ultra-thin TEM sample using a focused ion beam, the damage from ion beam scratches at the porous structure can be avoided or mitigated, thereby avoiding damage to the test sample.

In step S300 of FIG. 2, the chip test sample in the initial orientation is perpendicularly cut to obtain a sheet test sample that satisfies the requirements of subsequent observation.

Referring to FIGS. 8-10 to understand the perpendicular cutting of the test sample for obtain the thin sheet test sample. In an embodiment, a transmission electron microscope is applied to analyze the sheet test sample. The thickness of the sheet test sample should be less than 100 nanometers to allow electrons penetrate the sheet test sample so the electron diffraction image is clear.

In an embodiment, in order to form the first sheet test sample having a thickness thinner than 100 nm, a part of the sample can be sliced out by means of a focused ion beam, so that an ultra-thin sheet sample can be formed for imaging analysis. It should be noted that a person skilled in the art could use existing or future technologies to implement specific steps of slicing a part of the sample by means of a focused ion beam. The specific steps of performing slicing by means of a focused ion beam should not unduly limit the protection scope of the present application.

In an embodiment, the focused ion beam cuts the sheet sample from the perpendicular direction, a protective layer is first deposited on the top of the sheet sample, as shown in FIG. 8, to ensure that the focused ion beam does not cause damage to the sample when cutting a part of it.

In an embodiment, the material of the protective layer is metal platinum (Pt) or metal tungsten (W).

During the focused ion beam cutting process to form the ultra-thin sheet test sample, the ion beam typically processes from both front and rear directions on the test sample, completing the final ultra-thin area in the middle of the sheet test sample.

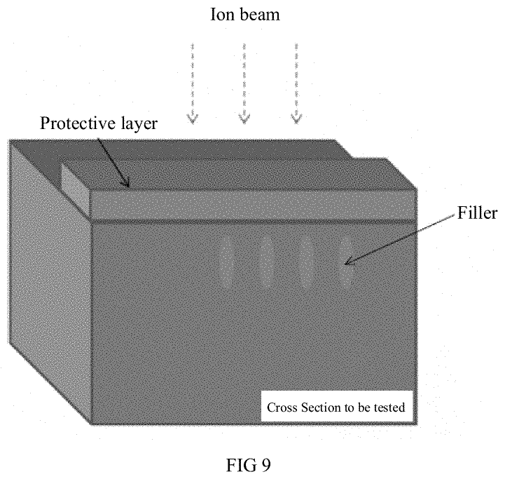

Therefore, referring to FIG. 9, final sample cutting is first performed at a first side of the chip test sample. that the filler originally The protruding filling material above the test sample surface is removed from the testing cross section area by gentle polishing on the sample surface, so the fillers are flat with the rest of the sample surface, shown in FIG. 9. The surface flatness of the testing area has to satisfy requirements for subsequent TEM imaging.

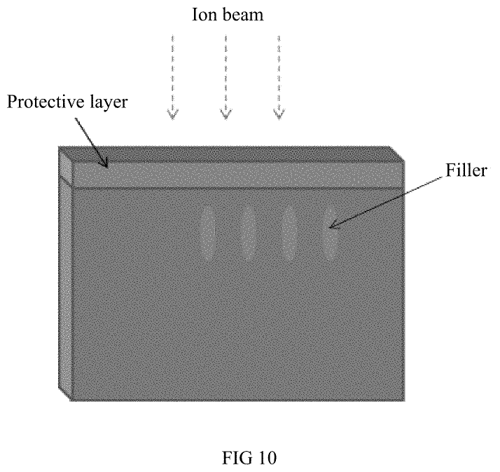

Referring to FIG. 10, after the first side of the test sample cutting is complete, the second side of the test sample is processed similarly as the first side described above, and the final sheet test sample is achieved as shown in FIG. 10.

FIG. 10 shows that the previously exposed porous structure cross is now filled with the filler. Therefore, no ion beam scratch is produced from focused ion beam acting on the porous structure during sample preparation, so the test sample is no longer damaged.

Since the thickness of the final sheet test sample is less than 100 nm, the porous structure of the final sheet test sample can be filled by erecting the test sample in steps S210-S230 so that the porous structure is fully filled with solid materials, ensuring that no ion beam scratch is produced from the porous structure.

A specific implementation method for preparing a TEM test sample for a chip according to the present application is described above. According to the method, the curtain effect near the porous structure from ion beam scratches can be effectively avoided by filling the pores in the porous structure before a TEM sample is finally thinned down, effectively improving the quality of the TEM sample, and thereby the TEM imaging quality.

Although the present disclosure is described with respect to specific exemplary embodiments, it is obvious that various modifications and changes can be made to these embodiments without departing from the broader spirit and scope of the present disclosure. Therefore, the specification and drawings should be construed as being illustrative rather than restrictive.

It should be understood that this specification will not be used to interpret or limit the scope or meaning of the claims. In addition, in the foregoing detailed description, it can be seen that various features are combined together in a single embodiment for the purpose of simplifying the present disclosure. The method of the present disclosure should not be construed as reflecting that the claimed embodiments require more features than those explicitly listed in each claim. On the contrary, as reflected in the appended claims, the inventive subject matter includes features less than all the features of a single disclosed embodiment. Therefore, the appended claims are hereby incorporated into the detailed description, with each claim independently used as an independent embodiment.

An embodiment or embodiments mentioned in the description are intended to be included in at least one embodiment of a circuit or method in combination with the specific features, structures, or characteristics described in the embodiment. The phrase “one embodiment” in various portions of the specification does not necessarily refer to the same embodiment.

What is claimed is:

1. A method for preparing a test sample of a semiconductor device, comprising steps of:
providing a sample substrate, wherein in an initial orientation, a side surface of the sample substrate exposes a cross section of a semiconductor device, wherein the cross section of the semiconductor device is to be tested, and wherein the the cross section comprises a porous structure;
depositing a filling material on the porous structure; and
cutting in a direction perpendicular to the sample substrate when the sample substrate is in an initial orientation to obtain a sheet test sample, wherein a side surface of the sheet test sample is the cross section to be tested.

2. The method for preparation the test sample according to claim 1, wherein the depositing a filling material on the porous structure further comprises steps of:
rotating an orientation of the sample substrate so the cross section to be tested is a top surface; wherein the filling material is deposited perpendicularly;
and
rotating the orientation of the sample substrate to the initial orientation.

3. The method for preparation the test sample according to claim 2, wherein the filling material is deposited in a process of electron beam assisted deposition.

4. The method for preparation the test sample according to claim 2, wherein the filling material is metal platinum (Pt) or metal tungsten (W).

5. The method for preparation the test sample according to claim 1, wherein the sample substrate is provide in steps of:
providing an initial substrate comprising the semiconductor device;
performing splitting processing on the initial substrate; and
selecting a portion of the initial substrate obtained after splitting as the sample substrate, wherein the portion contains the cross section of the semiconductor device to be tested.

6. The method for preparation the test sample according to claim 1, wherein before the cutting of the sample substrate in the initial orientation, the method further comprises:
polishing the side surface of the sample substrate.

7. The method for preparation the test sample according to claim 6, wherein the polishing is performed by a focused ion beam.

8. The method for preparation the test sample according to claim 1, wherein the perpendicular cutting is performed by a focused ion beam.

9. The method for preparation the test sample according to claim 1, wherein a thickness of the sheet test sample is less than 100 nanometers.

10. The method for preparation the test sample according to claim 1, wherein a side surface of the sheet test sample is imaged by a transmission electron microscope.
